(19) United States
(12) Patent Application Publication
(10) Pub. No.: US 2018/0354155 A1
(43) Pub. Date: Dec. 13, 2018

(54) Manufacturing Process and Resulting Products of Panels with Structural Edges in Pieces of Wood and Central Core in a Composition of Branch/Trunk Stumps and Resin

(71) Applicant: Jose Lucio Silvestre, Goioere (BR)

(72) Inventor: Jose Lucio Silvestre, Goioere (BR)

(21) Appl. No.: 15/830,941

(22) Filed: Dec. 4, 2017

(30) Foreign Application Priority Data
Jun. 13, 2017 (BR) 10 2017 012555 6

(51) Int. Cl. B27N 3/06; C09J 5/00; B27N 3/00; B27N 3/02; B27N 7/00; B27L 11/00

(52) U.S. Cl. CPC B27N 3/06; C09J 5/00; B27N 3/007; B27N 3/02; C09J 201/00; B27N 3/002; B27L 11/007; C09J 2497/006; B27N 7/00

(57) ABSTRACT

A manufacturing process is disclosed which relates to the technical field of the manufacture of wood panels, used in the manufacture of furniture, decorative pieces, floorings, partitions, stairs, doors and other applications in the construction industry, more specifically to a manufacturing process and products resulting from panels featuring structural edges made of pieces of wood and central core in a composition of branch/trunk stumps and resin. The invention presents as innovation, a manufacturing process (1) of decorative surface panels (2), using as raw material in their core and texture, tree branch and trunk stumps (3) originating from pruning or that were ripped off due to the action of the wind or natural causes, which have had resin applied (6) inside the structural base plates (4) of the desired shapes or part of them, consisting of ends or edges (5) made of pieces of wood, preferably reclaimed from the construction industry.

### CROSS REFERENCE TO RELATED APPLICATION

This application claims the benefit of and takes priority from Brazilian Patent application Serial No. BR 10 2017 012555 6 filed on Jun. 13, 2017, the contents of which are herein incorporated by reference.

### PRESENTATION

The present invention relates to the technical field of the manufacture of wood panels, used in the manufacture of furniture, decorative pieces, floorings, partitions, stairs, doors and other applications in the construction industry, more specifically to a manufacturing process and products resulting from panels featuring structural edges made of pieces of wood and central core in a composition of branch/trunk stumps and resin. The invention presents as innovation, the creation of panels with differentiated characteristics, which use as main raw material, in their core and texture, branch stumps and trunk stumps from trees originating from pruning or that were ripped off due to the action of the wind or due to natural causes, which are positioned and have resin applied to the structural base plates of the desired shapes or part of them, consisting of ends or edges made with pieces of wood, preferably reclaimed from the construction industry. Resulting in products with structures that are innovative and differentiated from the other processes and models found in the market.

### PRIOR ART AND PROBLEMS PRESENTED

As it is known by the technicians of the subject concerned, a wide variety of panels for the manufacture of furniture, decorative pieces, floorings and other applications in the construction industry can be presently found. Among these, we can mention PI0305791-7; BR102013008814-5; PI0605041-7 and BR102012020325-1.

PI0305791-7 describes a manufacturing process of furniture and objects made of solid marquetry, in which wood of various colors are cut in a circular saw and passed through a rougher to obtain bars with square sections, which are glued side by side with alternating colors, forming cubes or other geometric figures for the formation of various types of furniture.

BR102013008814-5 describes and claims a manufacturing and finishing process for furniture, which uses OSB as material with the application of sealant to anchor the paint. This results in furniture with textured embossing and with differentiated finish.

PI0605041-7 describes a manufacturing process of coating for furniture and ambient and products obtained, composed of the junction and bonding of various pieces of Formica for the formation of compact blocks, which are then cut and subsequently grouped and glued in opposite directions, forming textured tops.

BR102012020325-1 describes a technique for using babassu coconut for the manufacture of furniture. This invention has as its key factor the use of babassu coconut, after the procedure of removing its shell and kernel, whereas the coconut is sawn into slices and placed on a metal form where it is glued using a plastic compound (epoxy glue). Although there is a breadth of babassu coconut remains in the market, they are not sufficient to meet a great demand for furniture manufacturing. Another factor presented involves the similarity in texture between the parts, which usually present the same color. Differentiating itself from the proposed invention, where the same texture will never be found in other piece of furniture of the same segment.

All processes described are used in the same technical field, but are completely differentiated from the invention proposed.

### IMPROVEMENTS PRESENTED

The proposed invention was developed to differentiate itself and compete with existing processes and products for the manufacture of panels, used in the manufacture of furniture, decorative pieces, floorings, partitions and other applications in the construction industry. Whereas the main differences or improvements are:

it is a process that uses wood gathered directly from nature, i.e., dry tree branches or that were ripped off due to the action of the wind or other natural causes, or through lumber yards, where wood originating from pruning is sold to be transformed into wood chips or micro-lumber to feed boilers;

Its structure uses pieces of wood reclaimed from remains originating from the construction industry or demolition (leftovers from decks, rafters and beams and others), which are cut and processed in angles according to the edges of the structure's shape;

It reduces raw-material costs, in addition to being environmentally friendly; and

The products, although produced using an industrial process, result in differentiated and unique textures in each piece produced.

### DESCRIPTION OF THE INVENTION

This invention relates to a manufacturing process of tops, bases, doors and decorative surface panels for the manufacture of furniture, comprised by the use of branches and small trunks of wood originating from pruning and/or gathered in places where they have fallen due to the action from the wind or other causes; a step of cross-sectional cuts for the formation of small round stumps or in the shape of the edges of the branch or trunk section; a step of drying in the sun or in an oven; a step of manufacturing the structural piece of the panel which will compose the object, formed by a base plate in the desired shape (plywood, MDF, glass, among others) and by angled pieces of wood glued on their ends forming the edges of the panel; a step of placing the selected stumps over the central part of the panel's base plate; a step for filling with polyester, acrylic, epoxy or crystal resin, throughout the entire free space between the stumps positioned over the panel's base plate; a step for drying the resin; a step for levelling the piece through the use of a manual router or a CNC; a step for sanding for the application of sealant, epoxy resin (liquid glass) or varnish; and a step for polishing for the final finish of the piece.

The invention includes decorative panels formed by wood branch and trunk stumps that have had resin applied to them, with wood base and wood edges, made from the described process, which can be used in the manufacture of furniture, decorative pieces, floorings, partitions and other applications in the construction industry.

According to the invention, the decorative panels may feature a double-face texture, from which the base plate is taken.

According to the invention, the panels may dismiss the use of wood edges, leaving only the panel made with the branch/trunk stumps and resin.

### DESCRIPTION OF THE FIGURES

The objectives, benefits and other important features of the invention at hand may be more easily understood when read alongside the attached drawings, in which:

FIG. 01 represents a view of the block diagram of the manufacturing process and resulting products of panels with structural edges in pieces of wood and central core in a composition of branch/trunk stumps and resin.

FIG. 02 represents a perspective view of a table, made up of a top and a base resulting of the manufacturing process and resulting products of panels with structural edges in pieces of wood and central core in a composition of branch/trunk stumps and resin.

FIG. 03 represents a exploded view of the assembly of a table top manufactured through the process.

FIG. 04 represents an exploded view of the assembly and the application of resin of a tabletop manufactured through the process.

FIG. 05 represents a perspective view of the polishing for the final finish of a tabletop manufactured through the process.

FIG. 06 represents a perspective/bottom view of the feet of a table resulting of the manufacturing process and the resulting products of panels with structural edges in pieces of wood and central core in a composition of branch/trunk stumps and resin.

FIG. 07 represents a frontal view of a door manufactured with the panels from the manufacturing process and resulting products of panels with structural edges in pieces of wood and central core in a composition of branch/trunk stumps and resin.

FIG. 08 represents a perspective view of a panel without the edges, manufactured through the manufacturing process and resulting products of panels with structural edges in pieces of wood and central core in a composition of branch/trunk stumps and resin.

### DETAILED DESCRIPTION OF THE FIGURES

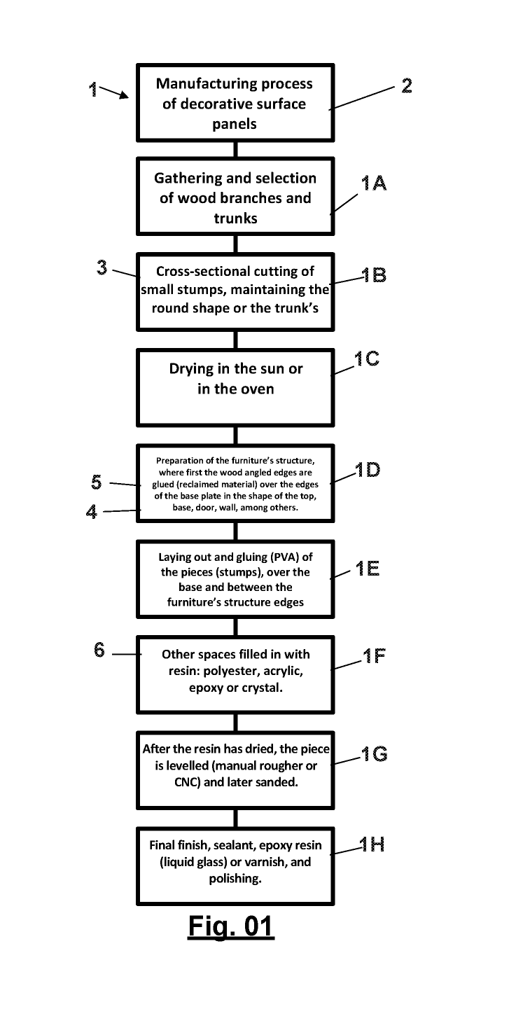

As it is evident in FIG. 01 in annex that illustrates and integrates the present invention of “Manufacturing Process and Resulting Products of Panels with Structural Edges in Pieces of Wood and Central Core in a Composition of Branch/Trunk Stumps and Resin”, it is a manufacturing process of panels for the manufacture of furniture or part of it, decorative pieces, floorings, partitions and other applications in the construction industry, comprised by a manufacturing process (1) of decorative surface panels (2), comprising: a step (1A) to gather dry branches from trees, branches ripped off by the action of the wind or other natural cause, or acquired in yards where pruned branches and small tree trunks are sent; a step (1B) of cross-sectional cutting to form small round stumps (3) or in the shape of the edges of the branch section or trunk; a step (1C) of drying in the sun or in an oven at a temperature of 70° Celsius; a step (1D) of manufacturing structural pieces, formed by a base plate (4) in the desired shape, where the edges of the branches are glued to pieces or angled edges (5), made of wood leftovers used in the construction industry (leftovers of decks, tips of beams, rafters, among others); a step (1E) of placing and laying out the selected round stumps (3), over the entire panel's base plate (4); a step (1F) of filling with polyester, acrylic, epoxy or crystal resin (6), throughout the entire free space of the core of the panel; a step (1G) where after the resin had dried, the piece is levelled through the use of an electric or manual router; step (1H) of sanding for the application of sealant, epoxy resin (liquid glass) or varnish and final finish through polishing.

The invention comprises decorative surface panels (2) resulting from the described manufacturing process (1).

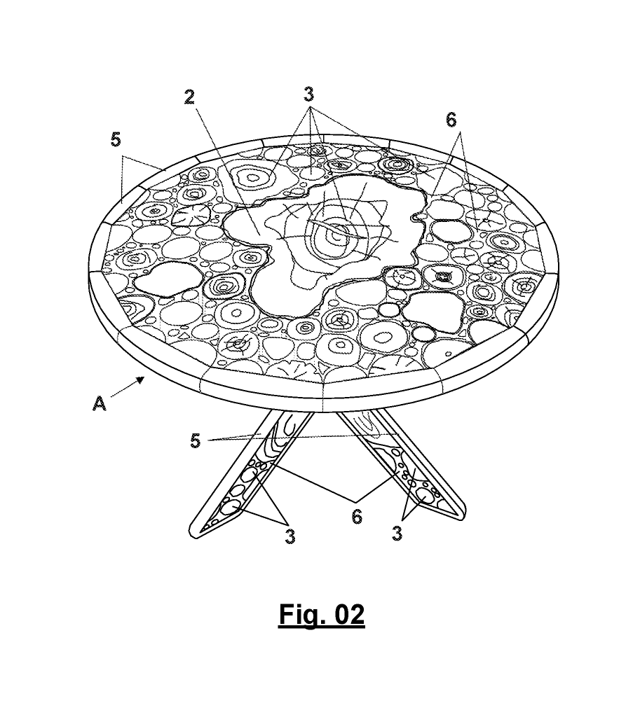

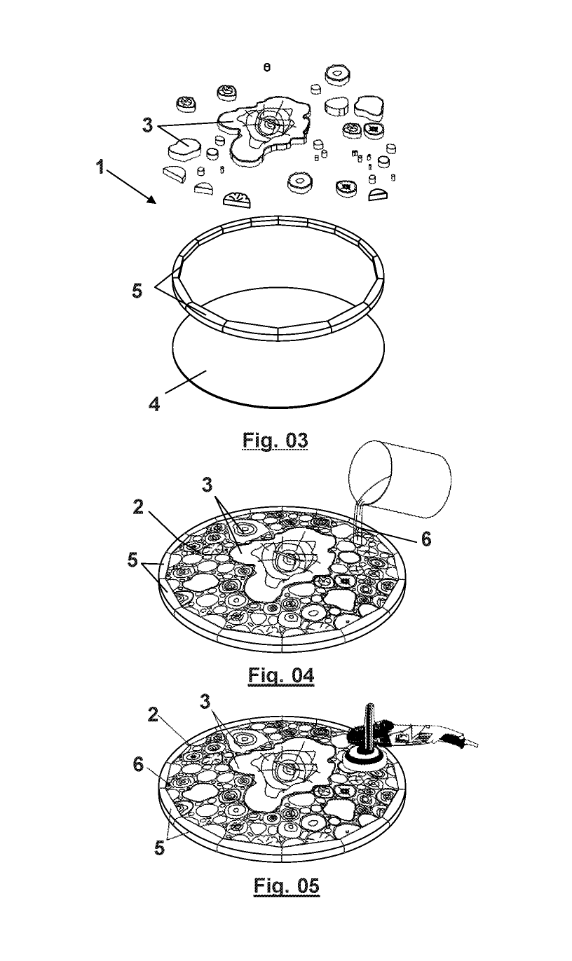

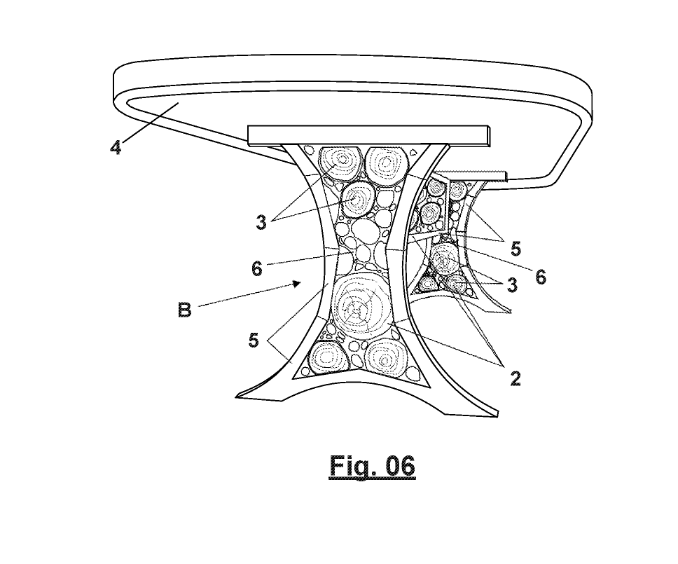

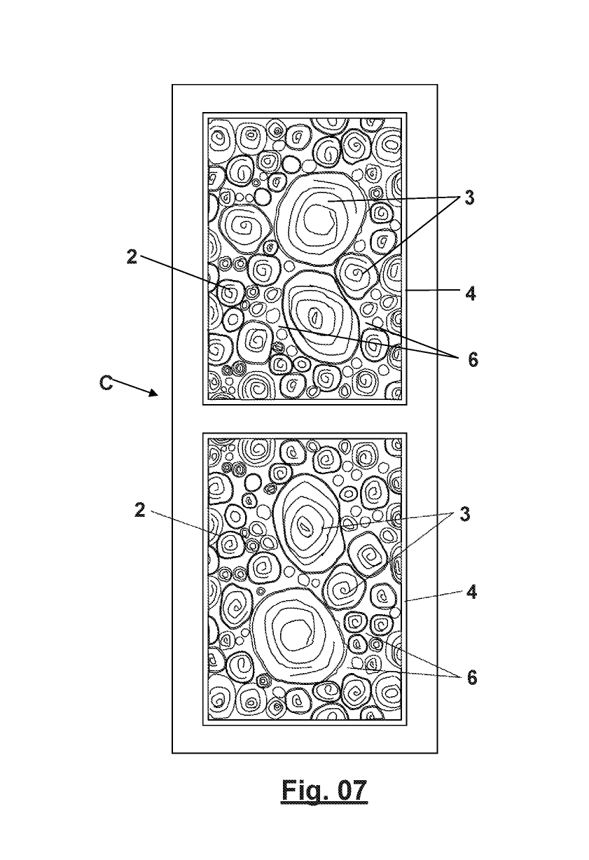

FIGS. 02, 03, 04, 05, 06 and 07 show the views of the manufacturing process (1) of a decorative surface panel (2), with the small round stumps (3) or in the shape of the edges of the branches or trunk, the resin (6), the base plate (4) and the angled pieces or edges (5), where there is evidence of some of their applications in the composition of the circular top and the feet of the table (A); the base of the table (B) and the central core or pads of a door (C).

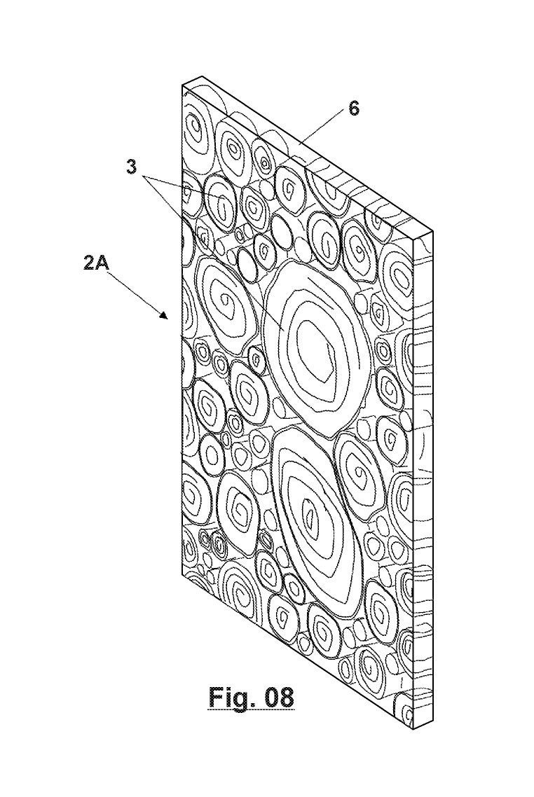

FIG. 8 shows a decorative surface panel (2), with the small round stumps (3) or in the shape of the edges of the branches or trunk with the resin (6), and without the edges and base plate.

The manufacturing process (1) of decorative surface panels (2) made of reclaimed wood and decorative core filled with branch/trunk stumps (3) and resin (6), described herein, are not limited to these provisions, configurations and measurements, provided that they retain the same predominant characteristics.

What is claimed is:

1. A manufacturing process of panels for the manufacture of furniture or part of it, decorative pieces, floorings, partitions and other applications in the construction industry, comprising:
a manufacturing process (1) of decorative surface panels (2), comprising:
a step (1A) of gathering dry tree branches, branches ripped off by the action of the wind or other natural cause, or acquired in yards where pruned branches and small tree trunks are sent;
a step (1B) of cross-sectional cutting to form small round stumps (3) or in the shape of the edges of the branches or trunk section;
a step (1C) of drying in the sun or in an oven at a temperature of 70° Celsius;
a step (1D) of manufacturing structural pieces, formed by a base plate (4) in the desired shape, where the edges of the branches are glued to pieces or angles edges (5), made of wood leftovers used in the construction industry (leftovers of decks, tips of beams, rafters, among others);
a step (1E) of placing and laying out the selected round stumps (3), over the entire panel's base plate (4);
a step (1F) of filling with polyester, acrylic, epoxy or crystal resin, throughout the entire free space of the core of the panel;
a step (1G) where after the resin had dried, the piece is levelled through the use of an electric or manual router; and
a step (1H) of sanding for the application of sealant, epoxy resin (liquid glass) or varnish and final finish through polishing.

2. The manufacturing process of claim 1, wherein the decorative surface panels (2) featuring a double-face texture, from which the base plate is taken.

3. The manufacturing process of claim 1, wherein the decorative surface panels (2) are formed by stumps of branches and wood trunks (3) and resin (6), with or without wooden base (4) wooden edges (5).

4. The manufacturing process of claim 3 wherein the furniture, decorative pieces, flooring, stairs, doors, partitions and other products used in civil construction, are made with decorative surface panels (2).
